(19) United States
(12) Patent Application Publication
(10) Pub. No.: US 2025/0387898 A1
(43) Pub. Date: Dec. 25, 2025

(54) Modular Storage System Container with Rolling Drawer

(71) Applicant: Milwaukee Electric Tool Corporation, Brookfield, WI (US)

(72) Inventors: George Barton, Mequon, WI (US); Charlie G. Noble, New Berlin, WI (US); Honesto D. Camposagrado, West Allis, WI (US); Christian R. Braun, Milwaukee, WI (US); Benjamin T. Jones, St. Francis, WI (US); Jedidiah J. Babinec, Milwaukee, WI (US)

(21) Appl. No.: 19/203,818

(22) Filed: May 9, 2025

Related U.S. Application Data
(60) Provisional application No. 63/662,580, filed on Jun. 21, 2024.
(60) Provisional application No. 63/693,814, filed on Sep. 12, 2024.

(51) Int. Cl. B25H 3/02

(52) U.S. Cl. CPC B25H 3/02

(57) ABSTRACT

Various embodiments of a modular storage system container with a rolling drawer are provided. In various embodiments, the container includes front wheels that are manually deployed. In various embodiments, the container includes front wheels that automatically deploy when the drawer is pulled out. In various embodiments, the drawer includes front wheels that act as the front wheels of the container. In various embodiments, the container includes a brake system.

### CROSS-REFERENCE TO RELATED PATENT APPLICATIONS

The present application claims benefit and priority to U.S. Provisional Application No. 63/693,814, filed on Sep. 12, 2024, and to U.S. Provisional Application No. 63/662,580 filed on Jun. 21, 2024, which are incorporated herein by reference their entireties.

### BACKGROUND OF THE INVENTION

The present disclosure is directed generally to modular storage systems. The present disclosure relates specifically to a storage container with a rolling drawer. Modular storage units, such as tool storage units are often used to transport tools and tool accessories.

### SUMMARY OF THE INVENTION

One embodiment of the invention relates to a mobile utility module with a main body and a drawer. The main body includes an upper surface, a female coupler defined in the upper surface, wheels coupled to the main body, and a cavity defined within the main body. The drawer includes one or more wheels coupled along a bottom wall of the drawer and an actuator extending outward from the drawer. The drawer is configured to be received within the cavity of the main body. The drawer is moveable between a storage position and an extended position in which the drawer extends beyond the main body. The one or more wheels of the drawer are moveable between a retracted position and a deployed position. When the actuator is engaged, the one or more wheels move away from the bottom wall of the drawer into the deployed position.

Another embodiment of the invention relates to a mobile utility module with a main body and a drawer. The main body includes an upper surface, a plurality of female couplers defined in the upper surface, and a cavity within the main body. The cavity is defined by a bottom wall, a rear wall, and side walls. The main body further includes wheels coupled to the side walls of the main body adjacent to the rear wall, two wheel housings, two front wheels, and two actuators. Each of the two wheel housings positioned at a front portion of one of the side walls and each of the two front wheels positionable within one of the two wheel housings. The two actuators are positioned within the cavity. The drawer is positionable within the cavity of the main body. When the drawer is moved into the cavity, the drawer engages the two actuators such that the two front wheels are moved to a deployed position.

Another embodiment of the invention relates to a mobile utility module with a main body and a drawer. The main body includes an upper surface, a plurality of female couplers defined in the upper surface, a cavity within the main body, and rear wheels coupled to the main body. The main body further includes a wheel housing positioned at a front portion of a side wall of the main body, a front wheel positioned within the wheel housing, and a lever extending outward from a front portion of the main body. The drawer is positionable within the cavity of the main body. The front wheel is moveable between a first, retracted position within the wheel housing and a second, extended position in which the wheel extends out from the wheel housing supporting the main body.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a rolling modular storage unit with a drawer removed, according to an exemplary embodiment.

FIG. 2 is a detailed perspective view of a female coupler, according to an exemplary embodiment.

FIG. 3 is perspective view of a male coupler, according to an exemplary embodiment.

FIG. 4 is a right side perspective view of the male coupler of FIG. 3, according to an exemplary embodiment.

FIG. 5 is a rear view of the rolling modular storage unit of FIG. 1, according to an exemplary embodiment.

FIG. 6 is a rear perspective view of the rolling modular storage unit of FIG. 1, according to an exemplary embodiment.

FIG. 7 is a rear perspective view from below of the rolling modular storage unit of FIG. 1, according to an exemplary embodiment.

FIG. 8 is a cross-sectional view of a braking system for a rolling modular storage unit with a break in a disengaged position, according to an exemplary embodiment.

FIG. 9 is a cross-sectional view of a braking system for a rolling modular storage unit with a break in an engaged position, according to an exemplary embodiment.

FIG. 10 is a rear perspective view from below of a rolling modular storage unit, according to an exemplary embodiment.

FIG. 11 is a right side perspective view the rolling modular storage unit of FIG. 10, according to an exemplary embodiment.

FIG. 12 is a rolling modular storage unit, according to another exemplary embodiment.

FIG. 13 is a detailed view of a wheel of the rolling modular storage unit of FIG. 12 in a deployed position, according to an exemplary embodiment.

FIG. 14 is a detailed view of the wheel of the rolling modular storage unit of FIG. 12 in a retracted position, according to an exemplary embodiment.

FIG. 15 is a detailed view of the wheel of the rolling modular storage unit of FIG. 12 in a retracted position, according to an exemplary embodiment.

FIG. 16 is a rolling modular storage unit with a drawer removed, according to another exemplary embodiment.

FIG. 17 is a perspective view from below of the rolling modular storage unit of FIG. 16, according to an exemplary embodiment.

FIG. 18 is a rear perspective view of the rolling modular storage unit of FIG. 16, according to an exemplary embodiment.

FIG. 19 is a perspective view of the rolling modular storage unit of FIG. 16, according to an exemplary embodiment.

FIG. 20 is a left side view of a rolling modular storage unit with wheels retracted, according to an exemplary embodiment.

FIG. 21 is a cross-sectional view of a rolling modular storage unit with wheels retracted, according to an exemplary embodiment.

FIG. 22 is a left side view of a rolling modular storage unit with wheels deployed, according to an exemplary embodiment.

FIG. 23 is a cross-sectional view of a rolling modular storage unit with wheels deployed, according to an exemplary embodiment.

FIG. 24 is a rolling modular storage unit, according to another exemplary embodiment.

FIG. 25 is a detailed view of a wheel system of the rolling modular storage unit of FIG. 24, according to an exemplary embodiment.

FIG. 26 is a detailed perspective view from below of the wheel system of the rolling modular storage unit of FIG. 24, according to an exemplary embodiment.

FIG. 27 is a detailed view of the wheel system of the rolling modular storage unit of FIG. 24, according to an exemplary embodiment.

FIG. 28 is a bottom view of the wheel system of the rolling modular storage unit of FIG. 24, according to an exemplary embodiment.

FIG. 29 is a cross-sectional view of a rolling modular storage unit with wheels in a retracted position, according to an exemplary embodiment.

FIG. 30 is a cross-sectional view of a rolling modular storage unit with wheels in a deployed position, according to an exemplary embodiment.

### DETAILED DESCRIPTION

Referring generally to the figures, various embodiments of a modular storage system container with a rolling drawer are provided, according to exemplary embodiments. The modular storage system container with a rolling drawer, shown as a rolling storage unit includes rollers or wheels along the bottom of the storage unit for easy rolling movement of the storage unit. The rolling storage unit includes a drawer that can be moved to extend out of the storage unit housing. As will be generally understood, a conventional rolling storage unit may require removing trays or objects stacked within the container portion of the rolling storage unit. Applicant believes the combination of the wheels on the rolling storage unit and a drawer provides improved mobility relative to a conventional drawer storage unit and improved ease of access to the objects stored within the rolling storage unit. The rolling storage units discussed herein with a drawer include wheel(s) allows for the opening of the drawer without unstacking any units or boxes engaged or stacked on the rolling storage unit.

In various embodiments, the container includes front wheels that are manually deployed. In such embodiments, the wheel(s) are stored within a portion of the container housing and then manually deployed when a lever or pedal is actuated. In various embodiments, the container includes front wheel(s) that automatically deploy when the drawer is pushed in or closed. In such embodiments, the wheel(s) are stored within a portion of the container and as the drawer is pulled out the wheel(s) are retracted. When the drawer is pulled out, the wheel(s) stay retracted until the drawer is adjacent to the housing. In other words, the wheel(s) do not deploy until the drawer is almost closed. In various embodiments, the drawer includes front wheel(s) that act as the front wheels of the container. In such embodiments, the wheel(s) are stored within a portion of the drawer and then manually deployed when a lever is actuated.

In various embodiments, the container includes a rolling drawer and a brake unit or system. In various specific embodiments, the brake system is positioned along a rear surface of the container housing and between wheels of the container. In various specific embodiments, a brake extends from the housing of the rolling storage to prevent the main body of the rolling storage unit from moving in the same direction as the drawer. In various specific embodiments, the housing of the rolling storage unit includes a lever, such as a step brake that is activated when the user steps on the lever, causing the brake to engage the ground.

In specific embodiments, the containers disclosed herein are configured with coupling mechanism(s) (e.g., male and/or female coupling component(s)) that are configured to engage with units of a modular storage system, such as a modular or stackable tool storage system, a modular worksite storage system, a modular transit storage system, etc. In various embodiments, the male and female couplers described herein and shown in the figures are compatible with the coupling mechanism(s) described in International Patent International Patent Publication No. WO 2017/191628, which is hereby incorporated by reference in its entirety.

In various embodiments, the female couplers and male couplers described herein engage with each other to rigidly couple together various components including such coupling structures. In various embodiments, the female couplers and male couplers described herein engage with each other to rigidly couple the utility modules that the female couplers and male couplers extend from. In a specific embodiment, the container discussed herein includes a lid with female couplers extending from an upper surface of the lid.

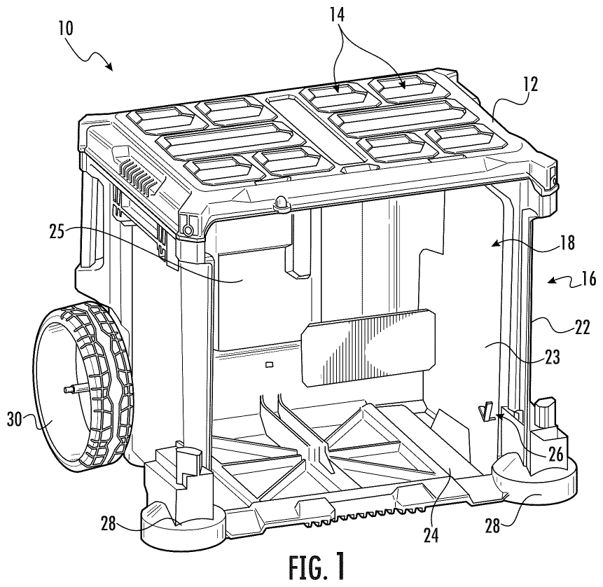

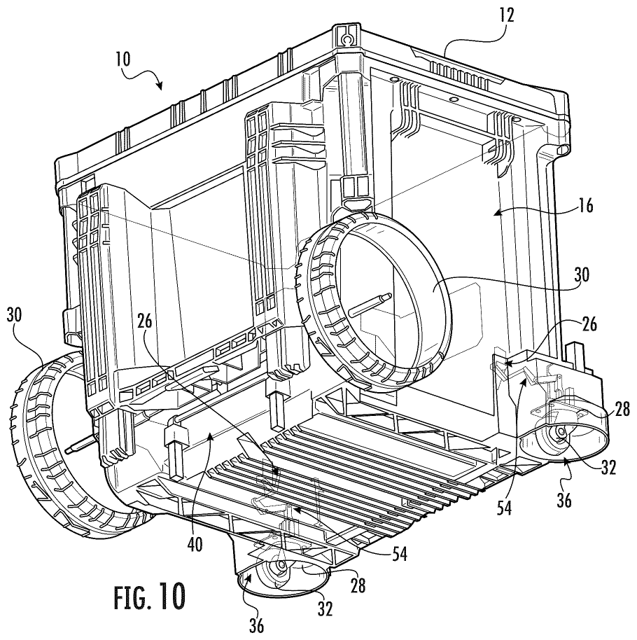

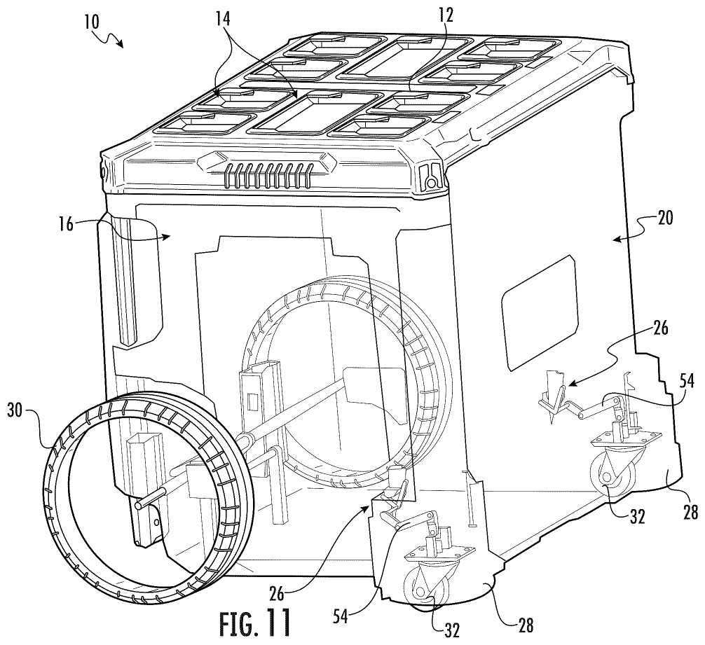

Referring to FIG. 1, various details of a modular storage system container, shown as a rolling utility module 10 are shown according to an exemplary embodiment. Rolling utility module 10 includes a housing 16 and a drawer (see e.g., element 20 in FIGS. 10-11) that is extendable from housing 16. Specifically, housing 16 defines a cavity 18 in which drawer 20 is positioned. As will be discussed in greater detail below, drawer 20 includes one or more rollers shown as wheel(s) 32 coupled to housing 16. In various specific embodiments, wheels 32 are caster wheels.

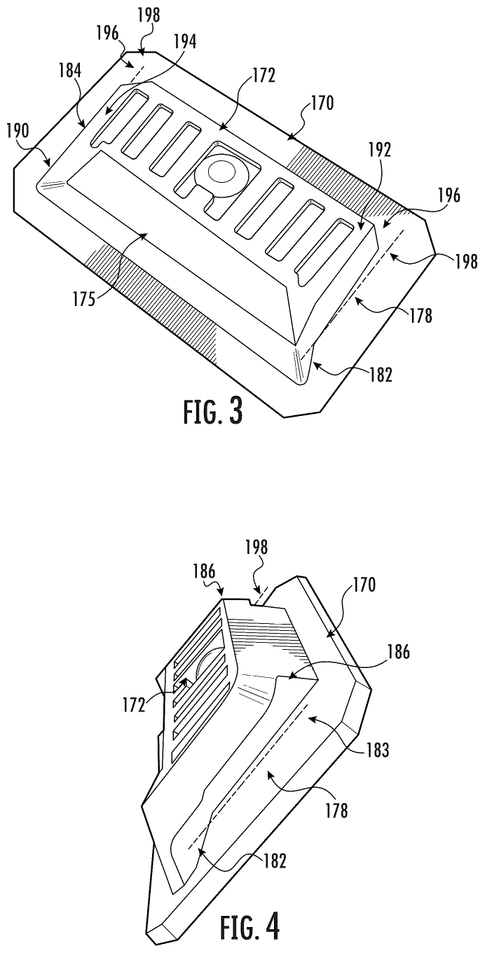

Rolling storage module 10 includes a lid with an upper surface 12 and an opposing lower surface facing away from the upper surface 12. One or more female couplers 14 extend from and/or are located in upper surface 12 of rolling storage module 10. The one or more female couplers 14 are configured to engage one or more male couplers (see e.g., male coupler 172 in FIG. 3) that extend from a surface such as a lower and/or rear surface of another utility module.

Housing 16 includes side walls 22, a bottom wall 24, and a rear wall 25. Side walls 22, bottom wall 24, rear wall 25 and the lid together define cavity 18. Side walls 22 each include an inner surface 23 that faces cavity 18. In various embodiments, an actuator 26 is positioned on inner surface 23 of each side wall 22. In other words, when there are two wheels 32, there will be two actuators 26 with an actuator 26 corresponding to each of the wheels 32. Housing 16 further includes one or more wheel housings 28 positioned at a front of one or more side walls 22. When actuator 26 is engaged or disengaged by drawer 20, wheel(s) 32 are deployed or retracted from wheel housing(s) 28 where they are stored within a cavity or space 36. Housing 16 includes wheels 30, shown as rear wheels 30 positioned adjacent to rear wall 25 and/or along side walls 22. In various specific embodiments, the rear wheels 30 have a first dimension and wheels 32 have a second dimension. In such embodiments, the first dimension is at least 2 times the second dimension. In various specific embodiments, rear wheels 30 have a first diameter and wheels 32 have a second diameter. In such embodiments, the first diameter is at least 2 times the second diameter.

Rolling storage module 10 and specifically housing 16 further includes a plurality of corner posts or pillars 34. In various specific embodiments, housing 16 includes two pillars 34 extending downward and connecting the lid to a projection positioned adjacent to wheels 30. In various embodiments, rolling storage module 10 includes pillars 34 extending between and connecting upper corners of the front of housing 16 to the opposing lower corners. In various specific embodiments, pillars 34 are formed from aluminum and are aluminum extrusion posts.

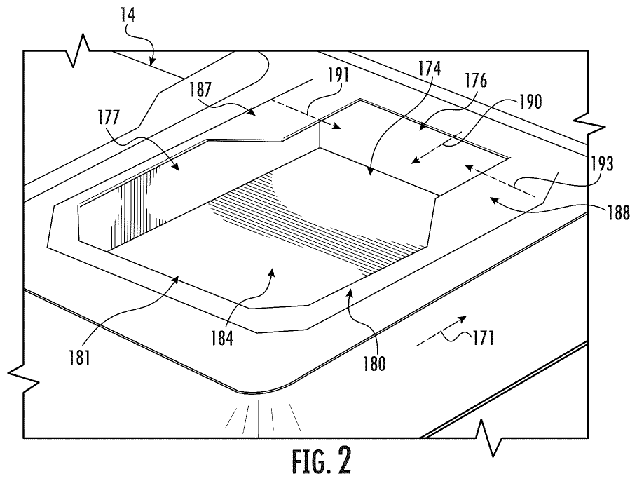

Referring to FIGS. 2-4, various details of male and female couplers that allow for engagement between a rolling storage unit and various other utility modules or storage devices are shown. Various aspects of a female coupler 150 are shown. Female coupler 150 can be utilized with utility storage module 10 and various other utility storage modules discussed herein.

Female coupler 150 includes a recessed surface 174 below a top or uppermost surface. Backwall 176, opposing front wall 181, first sidewall 178, and opposing second sidewall 180 extend upward from recessed surface 174. Female coupler 150 includes a pocket 184 collectively defined by recessed surface 174, backwall 176, front wall 181, first sidewall 178, and second sidewall 180.

First rib 187 extends from backwall 176 and first sidewall 177 above pocket 184 and/or recessed surface 174. In particular, first rib 187 extends in direction 191 from first sidewall 177 and first rib 187 extends in direction 190 from backwall 176. Second rib 188 extends from backwall 176 and second sidewall 180 above pocket 184 and/or recessed surface 174. In particular, second rib 188 extends in direction 193 from second sidewall 180 and second rib 188 extends in direction 190 from backwall 176. To couple female coupler 150 to a male coupler, such as male coupler 172, the male coupler 172 moves in direction 171 with respect to the female coupler 150.

Referring to FIGS. 3-4, in various embodiments, the utility module and/or storage device includes a male coupler 172 extending from a surface, such as surface 170 of the utility module and/or storage device. M ale coupler 172 includes a body 175 extending from the surface, a first tongue 186, and a second tongue 186. The first tongue 186 and the second tongue 186 both extend from the body 175 and both are offset from and above the surface. The first tongue 186 defines a first channel 198 between the back surface and the first tongue 186, and the second tongue 186 defines a second channel 198 between the back surface and the second tongue 186. The first channel 198 and second channel 198 each extend on opposing sides (e.g., first side 192 and opposing second side 194) of the body 175.

Each of first channel 198 and second channel 198 includes a front open end and a back closed end. For example, first channel 198 includes a front open end 183 and a back closed end 182, and second channel 198 includes a front open end 183 and a back closed end 182.

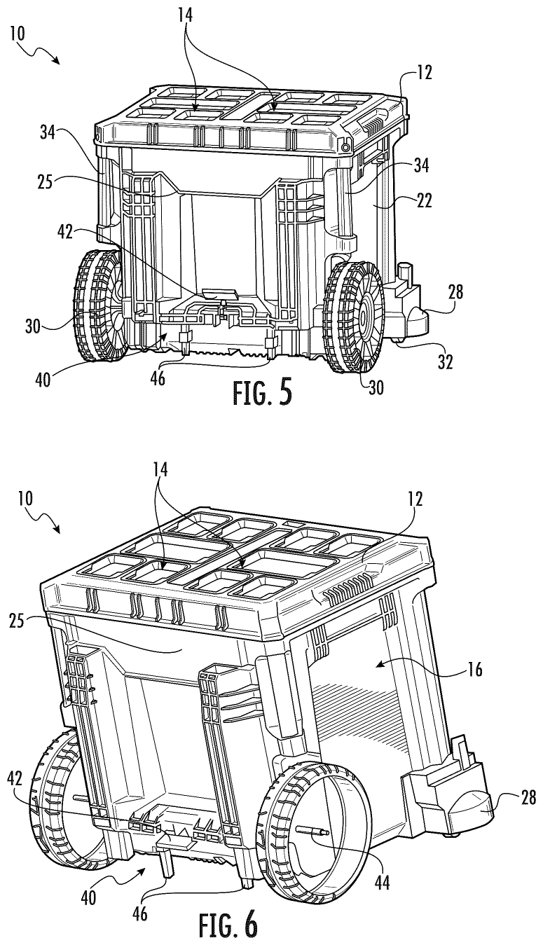

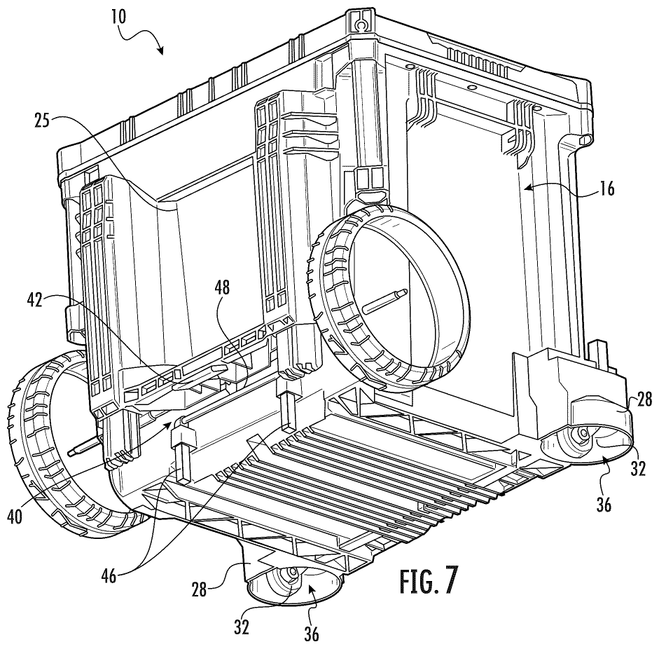

Referring to FIGS. 5-7, details of a braking system 40 that can be utilized with rolling utility module 10 are shown according to an exemplary embodiment. Braking system 40 is coupled to a rear portion of rolling utility module 10. In various embodiments, braking system 40 is positioned on the rear wall 25. In various embodiments, braking system 40 is positioned between rear wheels 30. As will be generally understood, braking system 40 is for use when wheels 30 and wheels 32 are contacting a ground surface 52 (see e.g., FIG. 9).

Braking system 40 includes an actuator shown as pedal 42, coupled to a rod, such as an axle 44, a linkage 50, and a brake 46. Pedal 42 actuates with respect to axle 44 which defines an axis of rotation. Linkage 50 connects pedal 42 to brake 46. In various embodiments, linkage 50 is an overcenter linkage. In various embodiments, brake 46 is an elongate brake that extends generally vertically along rolling utility module 10 and specifically rear wall 25. In various specific embodiments, brake 46 includes two elongate portions that extend generally vertically along rear wall 25. In such embodiments, the two elongate portions of brake 46 are coupled by a connector 48. Connector 48 extends in a generally perpendicular (e.g., 90 degrees plus or minus 10 degrees) from the direction of extension of the brake portions 46. In various embodiments, brake 46 is a bar. In various specific embodiments, brake 46 is a bar having a generally rectangular shape.

Brake 46 includes a first end coupled to connector 48 and/or linkage 50. In various embodiments, brake 46 includes a material on a second end surface that is adjacent to ground 52. In various embodiments, the material is a high friction material. In various embodiments, the material is a rubber material. Applicant believes the use of a non-marring surface improves friction and resists movement of rolling utility module 10 when brake system 40 is engaged.

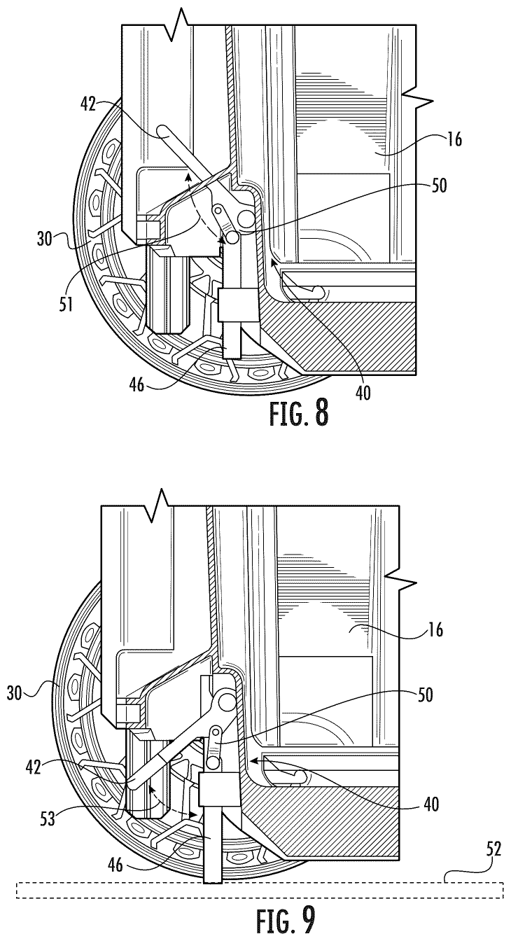

Referring to FIGS. 8-9, details of braking system 40 moving between an engaged and disengaged position are shown, according to an exemplary embodiment. As shown in FIG. 8, when braking system 40 is in a non-engaged position, brake 46 is spaced from or disengaged from a ground surface. Pedal 42 is shown positioned at a first angle 51 relative to rear wall 25 of rolling utility model 10 brake 46. When a user actuates pedal 42, pedal 42 moves to a second angle 53 relative to brake 46. The second angle 53 is less than the first angle 51. When pedal 42 is actuated, brake 46 moves downward and engages with ground surface 52. The engagement between brake 46 and ground 52 resists movement of rolling utility module 10 even with wheels 30, 32 all engaged with the ground 52.

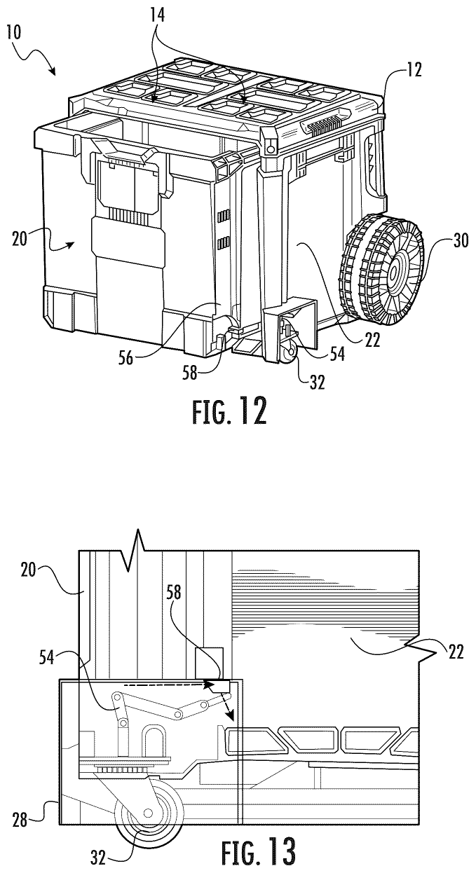

Referring to FIGS. 10-15, details of an automatic wheel deployment system that can be utilized with rolling utility module 10 and/or braking system 40 are shown according to an exemplary embodiment. As previously discussed, when drawer 20 is positioned within cavity 18 (i.e., in a closed position), wheels 32 will be deployed or dropped from a retracted position within wheel housings 28 into a lower position to engage the ground surface. Wheels 32 are coupled to housing 16 by a linkage 54. In various specific embodiments, linkage 54 is an over center linkage. In various specific embodiments, wheels 32 are caster wheels. In other embodiments, different types of rolling elements or wheels can be utilized.

The wheel(s) 32 are stored within wheel housing 28 of the rolling utility module 10 and as the drawer 20 is pulled out the wheel(s) 32 are retracted into the cavity 36 within wheel housing 28. When the drawer 20 is pulled out, the wheel(s) 32 stay retracted or disengaged from the ground surface until the drawer 20 is adjacent to the housing 16. In other words, the wheel(s) 32 do not deploy until the drawer 20 is almost closed or fully seated within cavity 18 and/or housing 16.

Drawer 20 includes a projection 58 extending outward (i.e., toward side wall 22) from a side surface 56 of drawer 20. In various embodiment, drawer 20 includes a pair of projections 58, with the projections 58 extending from opposing side surfaces 56 of drawer 20. Wheels 32 are automatically stowed or retracted when drawer 20 is pulled out of housing 16 to help rolling utility module 10 remain stationary. When a user pushes drawer 20 into a closed position, projections 58 engage with actuators 26 such that the wheels 32 automatically deploy when drawer 20 is closed.

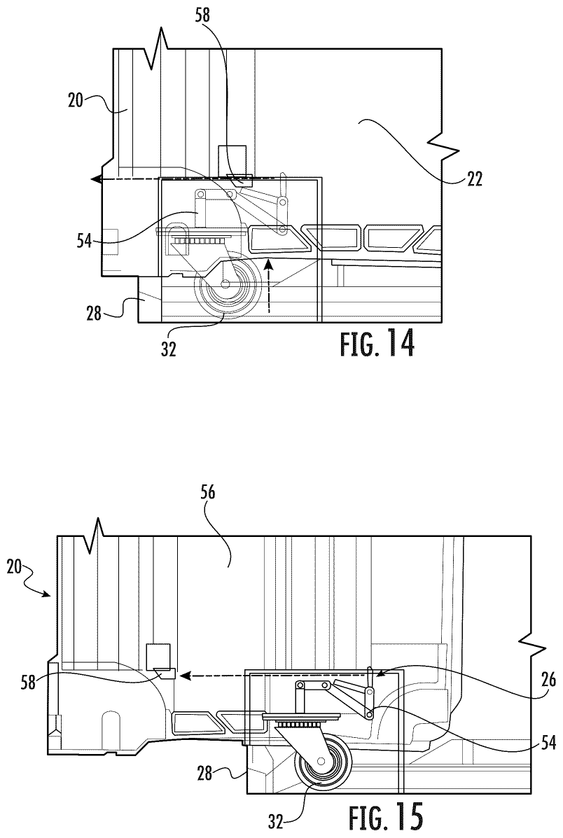

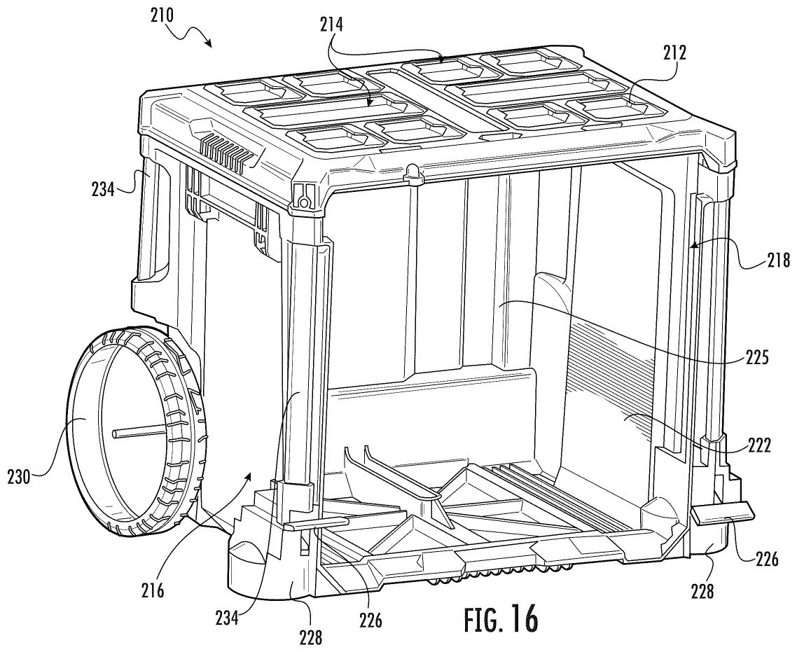

Referring to FIGS. 13-15, details of the deployment and retraction of wheels 32 are shown according to an exemplary embodiment. As shown in FIG. 13, when drawer 20 is closed and positioned within housing 16, wheels 32 are deployed from wheel housing 28 and move downward into engagement with the ground surface. As shown in FIG. 14, as drawer 20 is pulled out or moved away from cavity 18, wheel 32 moves upward into wheel housing 28 and into the retracted position. As shown in FIG. 15, wheel 32 remains in the retracted position within wheel housing 28 until drawer 20 is almost closed and projection 58 engages actuator 26 on housing 16.

Although the illustrated embodiment includes the actuators 26 on housing 16 and the projection 58 or activation component on drawer 20, in other embodiments, the projection is positioned on housing 16 within cavity 18 and the actuator is positioned on the drawer with the automatically deploying wheels coupled to the drawer.

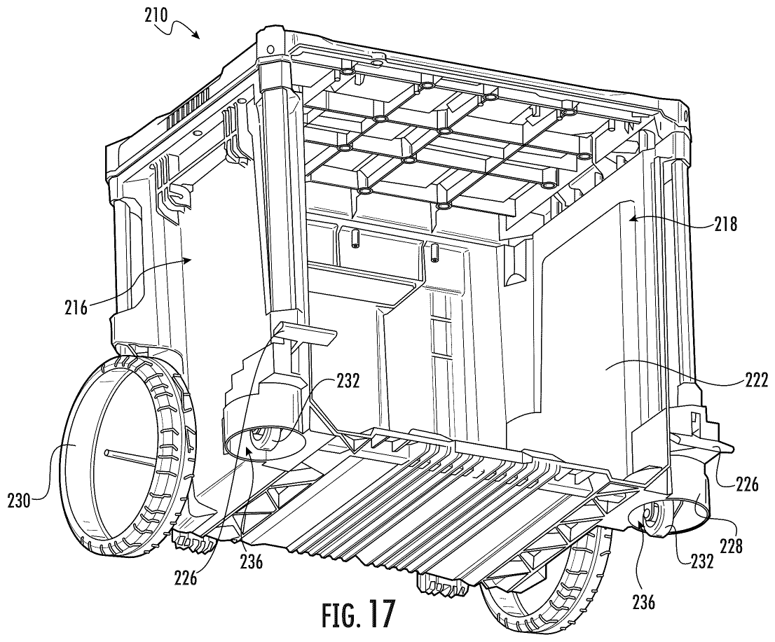

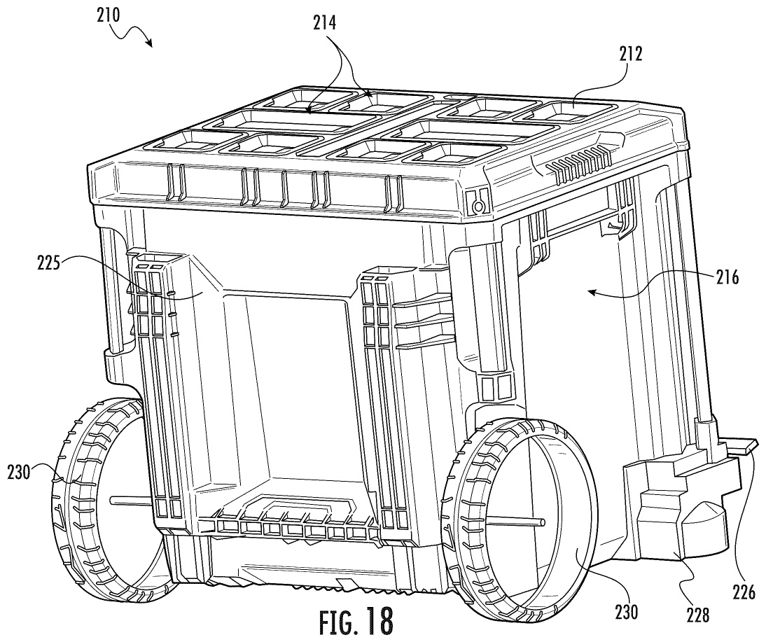

Referring to FIGS. 16-19, details of a manual wheel deployment system that can be utilized with rolling utility module 210 and/or braking system 40 are shown according to an exemplary embodiment. Rolling utility module 210 is substantially the same as rolling utility module 10 except for the differences discussed herein.

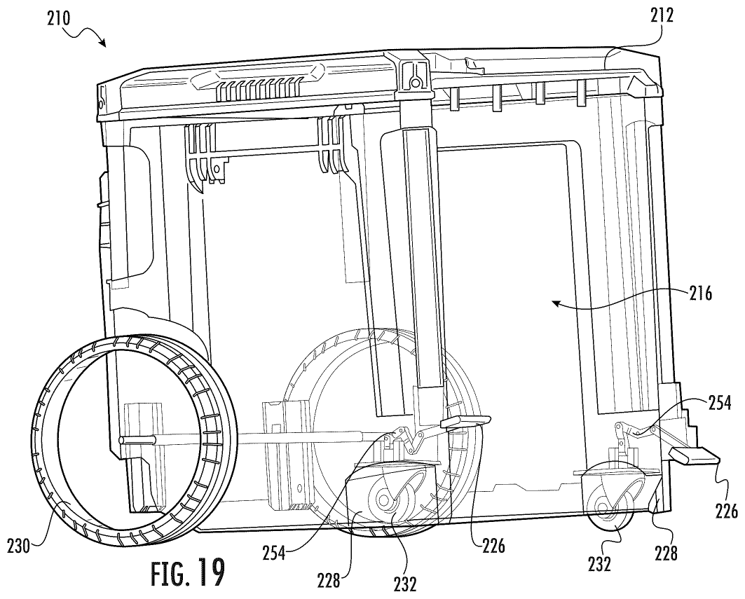

Rolling utility module 210 includes one or more actuators, shown as levers 226. Lever(s) 226 are positioned on housing 216 on a front portion of wheel housing 228. In various embodiments, there is a lever 226 corresponding to each wheel 232. In specific embodiments, there are two wheel housings 228, two wheels 232, and two levers 226 with one or each pair positioned on opposing sides of cavity 218. When a user wants to deploy wheels 232 of rolling utility module 210, the user actuates a lever 226 to deploy the wheel 232 linked to lever 226. In other words, for the manual activation system, the wheels 232 are deployed individually. As shown in FIG. 19, one of the levers 226 has been actuated and therefore the wheel 232 is deployed, while the other lever 226 has not been actuated and that wheel 232 is still in the retracted position.

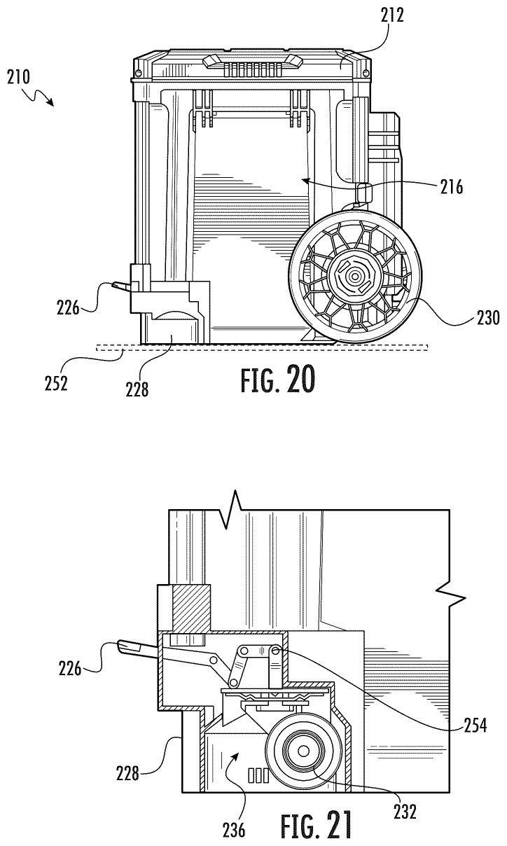

Referring to FIGS. 20-21, details of the rolling utility module 210 with wheels 232 in a retracted position, are shown according to an exemplary embodiment. When wheels 232 are in the retracted position, wheels 232 are positioned within wheel housing 228 and spaced or disengaged from ground surface 252. As such, only rear wheels 230 are engaged with ground surface 252 when wheels 232 are retracted.

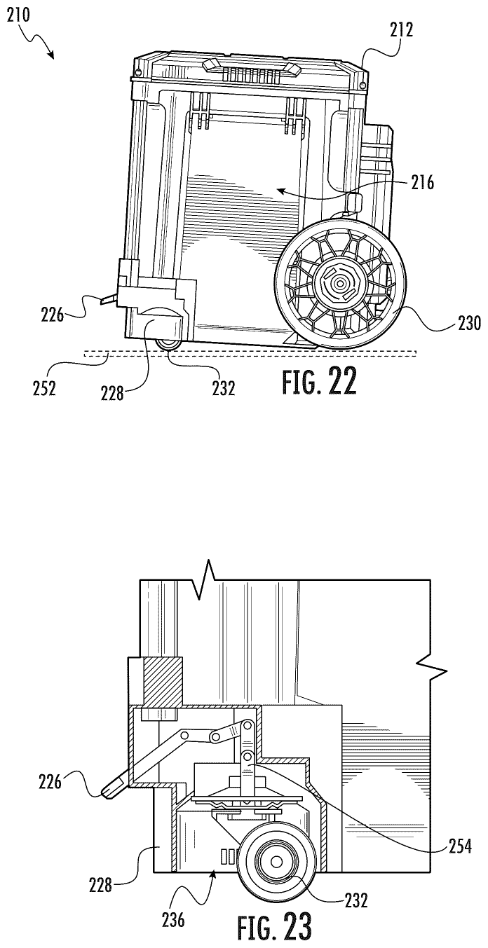

Referring to FIGS. 22-23, details of the rolling utility module 210 with wheels 232 in a deployed position, are shown according to an exemplary embodiment. When lever 226 has been actuated or pressed (downward in the orientation shown in FIG. 23), the linkage 254 moves wheel 232 into a deployed position. In the deployed position, wheel 232 is engaged with ground surface 252. When both levers 226 are actuated, both wheels 232 are moved into the deployed position such that all wheels 232, 230 are engaged with ground surface 252.

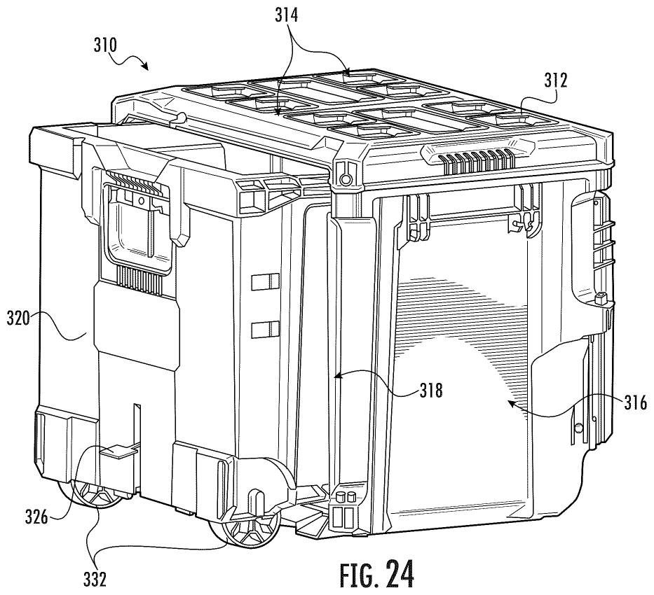

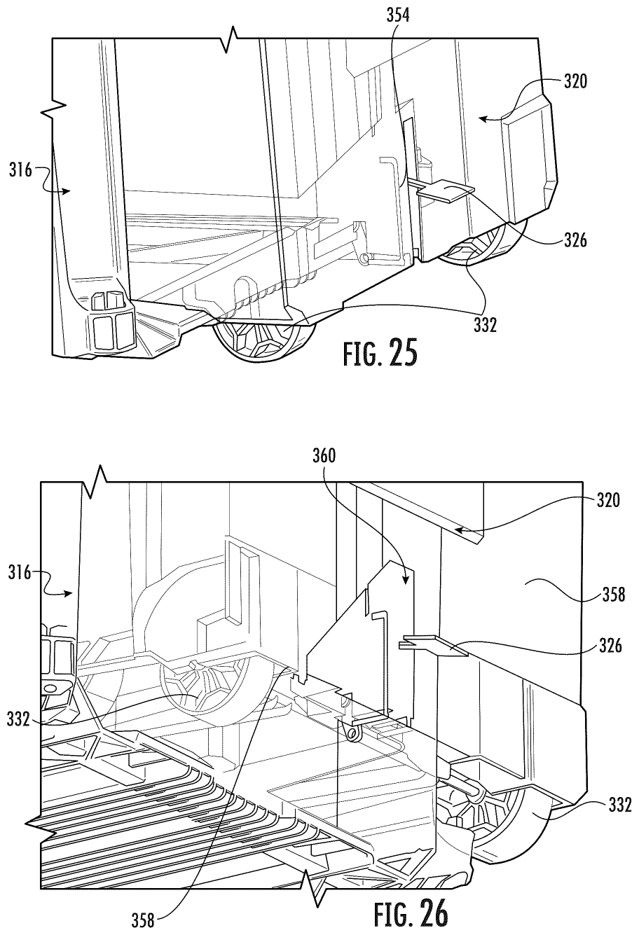

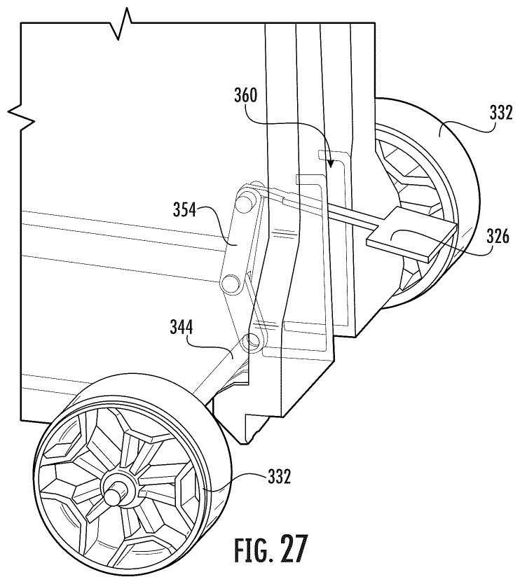

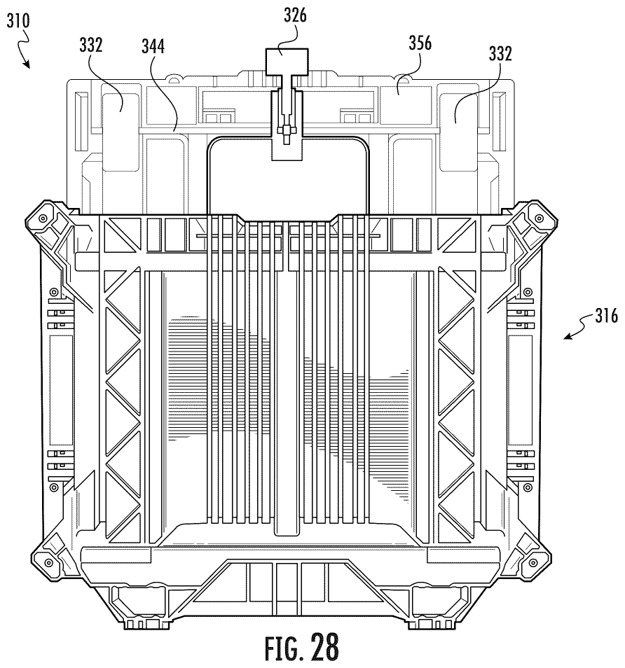

Referring to FIGS. 24-28, details of a manual wheel deployment system that can be utilized with rolling utility module 310 and/or braking system 40 are shown according to another exemplary embodiment. Rolling utility module 310 is substantially the same as rolling utility modules 10, 210 except for the differences discussed herein. The manual deployment system of rolling utility module 310 is substantially the same as rolling utility module 210 except for the differences discussed herein.

Rolling utility module 310 includes wheels 362, shown as rear wheels 362 positioned adjacent to rear wall and/or along side walls of housing 316. Rolling utility module 310 includes an actuator, shown as lever 326 coupled to a drawer 320. Wheels 332 are directly coupled to drawer 320. As such, the front wheels 332 are not attached to housing 316 of rolling utility module 310. Wheels 332 are coupled along a bottom wall 356 of drawer 320 adjacent to a front wall 358. A channel 360 is defined in front wall 358 of drawer 320. Lever 326 extends out from channel 360 beyond an exterior surface of front wall 358. Lever 326 is connected to linkage 354. In various embodiments, linkage 354 is an over center linkage. As will be generally understood, an over center linkage includes a system of one or more bars or links used to transmit motion. In such an embodiment, when the linkage 354 is rotated past it's center point, the linkage resists motion securing the linkage 354 in place. Linkage 354 is coupled to a rod, shown as an axle 344. Axle 344 extends between and connects both wheels 332. As such the single lever 326 manually deploys both wheels 332.

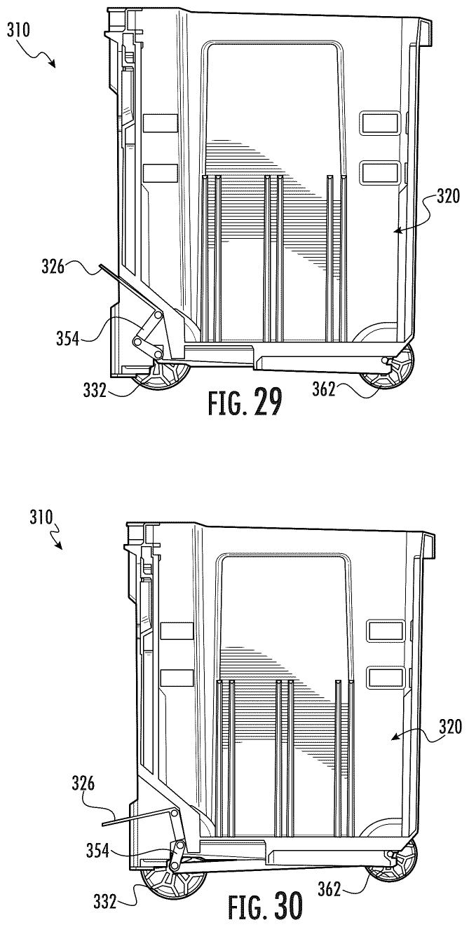

Referring to FIGS. 29-30, details the movement of wheels 332 between deployed and retracted positions are shown, according to an exemplary embodiment. As shown in FIG. 29, when lever 326 has not been engaged, wheels 332 are spaced from or disengaged from a ground surface. As such, only rear wheels 362 are engaged with the ground surface when wheels 332 are retracted. When a user actuates lever 326, both wheels 332 move downward away from bottom wall 356 of drawer 320 and engage with the ground surface.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A mobile utility module comprising:
a main body, the main body comprising:
an upper surface;
a female coupler defined in the upper surface;
wheels coupled to the main body; and
a cavity defined within the main body; and
a drawer comprising:
one or more wheels coupled along a bottom wall of the drawer, the drawer configured to be received within the cavity of the main body; and
an actuator extending outward from the drawer;
wherein the drawer is moveable between a storage position and an extended position in which the drawer extends beyond the main body;
wherein the one or more wheels of the drawer are moveable between a retracted position and a deployed position, wherein, when the actuator is engaged, the one or more wheels move away from bottom wall of the drawer into the deployed position.

2. The mobile utility module of claim 1, wherein the one or more wheels comprises a pair of wheels, the pair of wheels coupled together by an axle.

3. The mobile utility module of claim 2, further comprising one or more links extending between and coupling the axle to the actuator.

4. The mobile utility module of claim 3, wherein the one or more links comprise an over center linkage.

5. The mobile utility module of claim 1, wherein the drawer further comprises a channel defined in a front wall of the drawer, and wherein the actuator extends outward from the channel beyond an exterior surface of the drawer.

6. The mobile utility module of claim 1, wherein, when the one or more wheels are in the retracted position, the one or more wheels are received within a portion of the bottom wall.

7. The mobile utility module of claim 1, further comprising a brake coupled to the main body, wherein the brake is configured to engage a ground surface such that the brake resists movement of the wheels coupled to the main body.

8. The mobile utility module of claim 7, wherein the brake is coupled to a rear wall of the main body and positioned between the wheels of the main body.

9. A mobile utility module comprising:
a main body, the main body comprising:
an upper surface;
a plurality of female couplers defined in the upper surface;
a cavity within the main body, the cavity defined by a bottom wall, a rear wall, and side walls;
wheels coupled to the side walls of the main body adjacent to the rear wall;
two wheel housings, each of the wheel housings positioned at a front portion of one of the side walls;
two front wheels, each of the two front wheels positionable within one of the two wheel housings; and
two actuators positioned within the cavity; and
a drawer positionable within the cavity of the main body;
wherein, when the drawer is moved into the cavity, the drawer engages the two actuators such that the two front wheels are moved to a deployed position.

10. The mobile utility module of claim 9, wherein the two front wheels in the deployed position each extend beyond a respective bottom edge of one of the two wheel housings.

11. The mobile utility module of claim 9, wherein, when the drawer is moved out of the cavity, the drawer disengages from the two actuators such that the two wheels are retracted into cavities of the two wheel housings.

12. The mobile utility module of claim 9, wherein the two actuators are each positioned on an interior surface of one of the side walls.

13. The mobile utility module of claim 9, wherein the drawer further comprises two projections, each one of the two projections extending away from opposing exterior side surfaces of the drawer.

14. The mobile utility module of claim 13, wherein, when the drawer is moved into a closed position, the two projections engage the two actuators such that the two front wheels deploy and extend from the two wheel housings.

15. The mobile utility module of claim 9, further comprising a brake coupled to a rear wall of the main body, wherein the brake is configured to engage a ground surface such that the brake resists movement of the wheels of the main body.

16. The mobile utility module of claim 9, wherein the two front wheels are caster wheels.

17. A mobile utility module comprising:
a main body, the main body comprising:
an upper surface;
a plurality of female couplers defined in the upper surface;
a cavity within the main body;
rear wheels coupled to the main body;
a wheel housing positioned at a front portion of a side wall of the main body;
a front wheel positioned within the wheel housing; and
a lever extending outward from a front portion of the main body; and
a drawer positionable within the cavity of the main body;
wherein the front wheel is moveable between a first, retracted position within the wheel housing and a second, extended position in which the wheel extends out from the wheel housing supporting the main body.

18. The mobile utility module of claim 17, wherein, when the lever is actuated, the front wheel deploys into the second, extended position.

19. The mobile utility module of claim 17, further comprising a linkage extending between and connecting the lever to the front wheel.

20. The mobile utility module of claim 17, further comprising a brake coupled to the main body and positioned between the rear wheels, wherein the brake comprises a pair of elongate portions that extends along a longitudinal axis of the main body.
